(19) United States
(12) Patent Application Publication
(10) Pub. No.: US 2021/0407395 A1
(43) Pub. Date: Dec. 30, 2021

(54) PIXEL CIRCUIT AND DISPLAY DEVICE HAVING SAME

(71) Applicant: SHENZHEN CHINA STAR OPTOELECTRONICS SEMICONDUCTOR DISPLAY TECHNOLOGY CO., LTD., SHENZHEN, GUANGDONG (CN)

(72) Inventors: JIANXIN LIU, SHENZHEN, GUANGDONG (CN); BAIXIANG HAN, SHENZHEN, GUANGDONG (CN)

(21) Appl. No.: 16/756,193

(22) PCT Filed: Mar. 27, 2020
(86) PCT No.: PCT/CN2020/081768

§ 371 Date: Apr. 15, 2020

(30) Foreign Application Priority Data
Jan. 9, 2020 (CN) 202010021991.7

(51) Int. Cl. G09G 3/3225

(52) U.S. Cl. CPC G09G 3/3225; G09G 2300/0842; G09G 2310/0202; G09G 2300/0809; G09G 2300/0426

(57) ABSTRACT

A pixel circuit and a display device are provided. The pixel circuit includes three transistors, a storage capacitor, a light emitting device, a data line, a scan line, and a detection signal line. A control electrode of a third transistor in a nth row is connected to a scan line in a n+1th row. The scan lines in adjacent rows have at least half of pulses being the same. A second transistor and the third transistor are separately controlled to improve detection accuracy of a threshold voltage and improve compensation accuracy of the pixel circuit.

### FIELD OF INVENTION

The present disclosure relates to the field of circuit and pixel driving. technologies, and more particularly to a pixel circuit and display device having the same.

### BACKGROUND OF INVENTION

At present, bottom-emission active matrix organic light emitting diode (AMOLED) panels employ a pixel structure of a single scan line in order to increase an aperture ratio. However, the pixel structure of the single scan line lacks flexibility of voltage compensation, reduces detection accuracy, and has certain defects.

### Technical Problem

In the prior art, there is an issue that it is difficult to balance a high aperture ratio of a pixel unit and compensation accuracy of a pixel circuit.

### SUMMARY OF INVENTION

An embodiment of the present invention provides a pixel circuit, comprising pixel unit circuits arranged in a row. Each of the pixel unit circuits comprises a first transistor, a second transistor, a third transistor, a storage capacitor, a light emitting device, a data line, a scan line, and a detection signal line. A drain of the first transistor of the pixel unit circuit in a nth row is connected to a first power line to receive a first voltage; a control electrode of the second transistor is connected to the scan line, a first electrode of the second transistor is connected to the data line, and a second electrode of the second transistor is connected to a control electrode of the first transistor and an electrode of the storage capacitor; a control electrode of the third transistor is connected to the scan line of the pixel unit circuit in a n+1th row, a first electrode of the third transistor is connected to the detection signal line, and a second electrode of the third transistor is connected to a source of the first transistor, another electrode of the storage capacitor, and an end of the light emitting device; another end of the light emitting device is connected to a second power line to receive a second voltage; the scan lines of the pixel unit circuits in adjacent rows have at least half of pulses being the same.

An embodiment of the present invention provides a display device comprising a pixel circuit comprising pixel unit circuits arranged in a row. Each of the pixel unit circuits comprises a first transistor, a second transistor, a third transistor, a storage capacitor, a light emitting device, a data line, a scan line, and a detection signal line. A drain of the first transistor of the pixel unit circuit in a nth row is connected to a first power line to receive a first voltage; a control electrode of the second transistor is connected to the scan line, a first electrode of the second transistor is connected to the data line, and a second electrode of the second transistor is connected to a control electrode of the first transistor and an electrode of the storage capacitor; a control electrode of the third transistor is connected to the scan line of the pixel unit circuit in a n+1th row, a first electrode of the third transistor is connected to the detection signal line, and a second electrode of the third transistor is connected to a source of the first transistor, another electrode of the storage capacitor, and an end of the light emitting device; another end of the light emitting device is connected to a second power line to receive a second voltage; the scan lines of the pixel unit circuits in adjacent rows have at least half of pulses being the same.

Beneficial Effect:

The control electrode of the third transistor of the pixel unit circuit in the nth row is connected to the scan line of the pixel unit circuit in the n+1th row. A pulse relationship of the scan lines of the pixel unit circuits in the adjacent rows is controlled. This improves detection accuracy of a threshold voltage, thereby improving compensation accuracy of the pixel circuit. In addition, a pixel structure of a single scan line is used to ensure a high aperture ratio of the pixel unit and achieve better display performance.

### DESCRIPTION OF DRAWINGS

FIG. 1 is an equivalent schematic diagram of a pixel circuit according to an embodiment of the present invention.

FIG. 2 is a timing diagram of a pixel circuit according to an embodiment of the present invention.

FIG. 3 is a timing diagram of a pixel circuit according to another embodiment of the present invention.

FIG. 4 is an equivalent schematic diagram of a pixel unit circuit according to another embodiment of the present invention.

FIG. 5 is a timing diagram of a pixel unit circuit according to another embodiment of the present invention.

### DETAILED DESCRIPTION OF PREFERRED EMBODIMENTS

In order to make objectives, technical solutions, and advantages of the present invention clearer, the present invention is further described in detail below with reference to the accompanying drawings and embodiments. Without conflict, the following embodiments and their technical features can be combined with each other. It should be understood that the specific embodiments described herein are only used to explain the present invention and are not intended to limit the present invention.

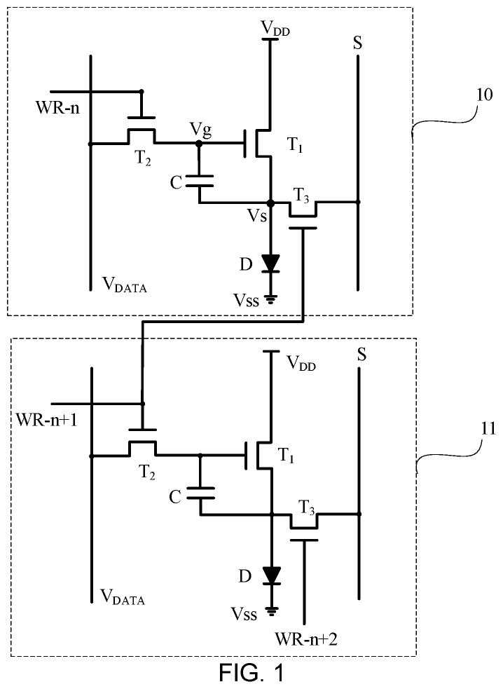

Referring to FIG. 1, an embodiment of the present invention provides a pixel circuit. The pixel circuit includes pixel unit circuits in a matrix distribution. The pixel unit circuit includes a first transistor T1, a second transistor T2, a third transistor T3, a storage capacitor C, a light emitting device D, a data line V_{DATA}, a scan line WR, and a detection signal line S. The first transistor T1, the second transistor T2, and the third transistor T3 may be thin film transistors. The light emitting device D may be an active matrix organic light emitting diode (AMOLED) or other light emitting devices.

A drain of the first transistor T1 of the pixel unit circuit 10 in a nth row is connected to a first power line to receive a first voltage V_{DD}. A control electrode of the second transistor T2 is connected to a scan line WR-n of the pixel unit circuit 10. A first electrode of the second transistor T2 is connected to a data line VDATA of the pixel unit circuit 10. A second electrode of the second transistor T2 is connected to a control electrode of the first transistor T1 of the pixel unit circuit 10 and one of electrodes of the storage capacitor C. A first electrode of the second transistor T2 may be a source or a drain, and a corresponding second stage, which is not limited herein. A first electrode of the third transistor T3 is connected to a detection signal line S of the pixel unit circuit 10. A second electrode of the third transistor T3 is connected to the source of the first transistor T1 of the pixel unit circuit 10, another electrode of the storage capacitor C, and one end of the light emitting device D. A gate of the third transistor T3 of the pixel unit circuit 10 in the nth row is connected to a scan line WR-n+1 of the pixel unit circuit 11 in a n+1th row. The first electrode of the third transistor T3 may be a source or a drain, and a corresponding second stage, which is not limited herein. In addition, in the pixel unit circuit 10, another end of the light emitting device D is connected to a second power line to receive a second voltage V_{SS}. The second power line may be grounded, and the second voltage V_{SS} may be 0 V.

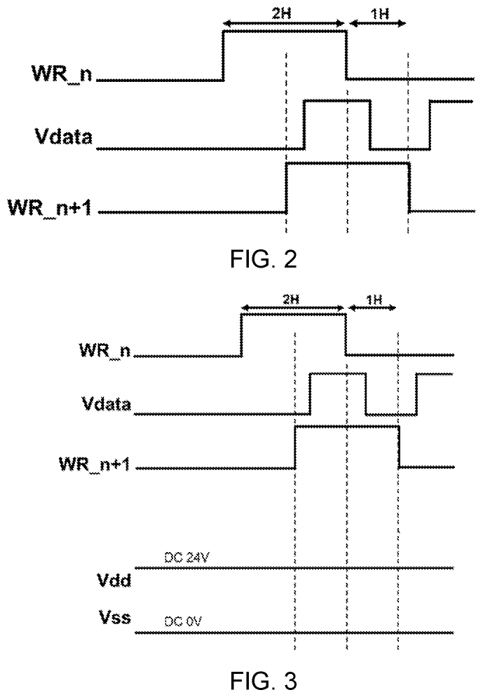

In addition, in the pixel circuit provided by an embodiment of the present invention, at least half of pulses of the scan line signals of the pixel unit circuits of adjacent rows are the same. The scan lines of the pixel unit circuits of adjacent rows have at least half of pulses being the same, which may be: in the pixel circuit, at least half of pulse signals of the scan lines in previous and next rows of pixel unit circuits are at the same time at a high level signal. This causes the second transistor T2 and the third transistor T3 controlled by scan line signals in previous and next rows to be turned on at the same time. As an implementable manner, pulse signal diagram of the scan lines of the pixel unit circuits of the adjacent rows may refer to FIG. 2. When the scan line WR-n of the pixel unit circuit 10 in the nth row is in a high-level state, the second transistor T2 of the pixel unit circuit 10 in the row is turned on for 1H, where 1H is equal to the maximum time of the pixel per row scanning at a specific frequency in one second, the scan line WR-n+1 of the pixel unit circuit in the n+1th row is also raised to a high-level state. At this time, the second transistor T2 and the third transistor T3 in the pixel unit circuit 10 in the nth row are turned on at the same time. The data line V_{DATA} is then also raised to a high-level state to turn on the first transistor T1 in the pixel unit circuit 10, and starts to charge the storage capacitor C, and drives the light emitting device D to start emitting light. After the scan line WR-n+1 of the pixel unit circuit 11 in the n+1th row is raised to the high-level state for 1H time, the scan line WR-n of the pixel unit circuit 10 in the nth row is lowered to the low-level state. The second transistor T2 is turned off. The first transistor T1 is still turned on because the storage capacitor C starts to discharge to the outside. The voltage at the gate point V_{S} of the first transistor T1 is raised. The voltage at the source point Vg of the first transistor T1 is coupled by the capacitor C due to the voltage drift. At this time, the gate-source voltage Vgs of the first transistor T1 detected by the detection signal line S is almost unchanged, where Vgs=Vg-Vs.

After the detection signal line S detects and obtains a more accurate gate-source voltage Vgs of the first transistor T1, the data is transmitted to a processing chip and the compensation voltage is started to be calculated. The voltage of the data line V_{DATA} in the next frame is adjusted according to the compensation voltage to achieve voltage compensation for the pixel circuit.

In the pixel circuit, the control electrode of the third transistor T3 of the pixel unit circuit 10 in the nth row is connected to the scan line WR-n+1 of the pixel unit circuit 11 in the n+1th row, and at least half of pulses of the scan lines of the pixel unit circuits in the adjacent rows are controlled to be the same. This makes the gate-source voltage detected by the detection signal line S more accurate, improves detection accuracy of the pixel circuit, thereby improving compensation accuracy of the pixel circuit. In addition, a pixel circuit structure of a single scan line is used to ensure a high aperture ratio of the pixel structure and achieve better display performance.

Another embodiment of the present invention provides a pixel circuit. The pixel circuit includes pixel unit circuits in a matrix distribution. The pixel unit circuit includes a first transistor T1, a second transistor T2, a third transistor T3, a storage capacitor C, a light emitting device D, a data line V_{DATA}, a scan line WR, and a detection signal line S. The first transistor T1, the second transistor T2, and the third transistor T3 may be thin film transistors. The light emitting device D may be an active matrix organic light emitting diode (AMOLED) or other light emitting devices.

Referring to FIG. 1, a drain of the first transistor T1 of the pixel unit circuit 10 in a nth row is connected to a first power line to receive a first voltage V_{DD}. A control electrode of the second transistor T2 is connected to a scan line WR-n of the pixel unit circuit 10. A first electrode of the second transistor T2 is connected to a data line V_{DATA} of the pixel unit circuit 10. A second electrode of the second transistor T2 is connected to a control electrode of the first transistor T1 of the pixel unit circuit 10 and one of electrodes of the storage capacitor C. A first electrode of the second transistor T2 may be a source or a drain, and a corresponding second stage, which is not limited herein. A first electrode of the third transistor T3 is connected to a detection signal line S of the pixel unit circuit 10. A second electrode of the third transistor T3 is connected to the source of the first transistor T1 of the pixel unit circuit 10, another electrode of the storage capacitor C, and one end of the light emitting device D. A control electrode of the third transistor T3 of the pixel unit circuit 10 in the nth row is connected to a scan line WR-n+1 of the pixel unit circuit 11 in a n+1th row. The first electrode of the third transistor T3 may be a source or a drain, and a corresponding second stage, which is not limited herein. In addition, in the pixel unit circuit 10, another end of the light emitting device D is connected to a second power line to receive a second voltage. The second power line may be grounded, and the second voltage may be 0 V.

In addition, in the pixel circuit provided by an embodiment of the present invention, at least half of pulses of the scan line signals of the pixel unit circuits of adjacent rows are the same. The scan lines of the pixel unit circuits of adjacent rows have at least half of pulses being the same, which may be: in the pixel circuit, at least half of pulse signals of the scan lines in previous and next rows of pixel unit circuits are at the same time at a high level signal. This causes the second transistor T2 and the third transistor T3 controlled by scan line signals in previous and next rows to be turned on at the same time. As an implementable manner, pulse signal diagram of the scan lines of the pixel unit circuits of the adjacent rows may refer to FIG. 2. The detection signal line S provides a reference voltage for the pixel unit circuit 10, the drain of the first transistor T1 is connected to an operating voltage of 24 V, and another end of the light emitting device D is grounded. When the scan line WR-n of the pixel unit circuit 10 in the nth row is in a high-level state, the second transistor T2 of the pixel unit circuit 10 in the row is turned on for 1H, the scan line WR-n+1 of the pixel unit circuit in the n+1th row is also raised to a high-level state. At this time, the second transistor T2 and the third transistor T3 in the pixel unit circuit 10 in the nth row are turned on at the same time. The data line V_{DATA} is then also raised to a high-level state to turn on the first transistor T1 in the pixel unit circuit 10, and starts to charge the storage capacitor C, and drives the light emitting device D to start emitting light. After the scan line WR-n+1 of the pixel unit circuit 11 in the n+1th row is raised to the high-level state for 1H time, the scan line WR-n of the pixel unit circuit 10 in the nth row is lowered to the low-level state. The second transistor T2 is turned off. The first transistor T1 is still turned on because the storage capacitor C starts to discharge to the outside. The voltage at the gate point Vs of the first transistor T1 is raised. The voltage at the source point Vg of the first transistor T1 is coupled by the capacitor C due to the voltage drift. At this time, the gate-source voltage Vgs of the first transistor T1 detected by the detection signal line S is almost unchanged, where Vgs=Vg−Vs.

In an embodiment of the present invention, the pixel circuit further comprises the scan line in a last row connected to the control electrode of the third transistor T3 of the pixel unit circuit in a last row. This realizes control of the third transistor T3 of the pixel unit circuit in the last row. The scan line in the last row can be arranged below the pixel unit circuit in the last row, ensuring a high aperture ratio of the pixel circuit and achieving more accurate voltage compensation.

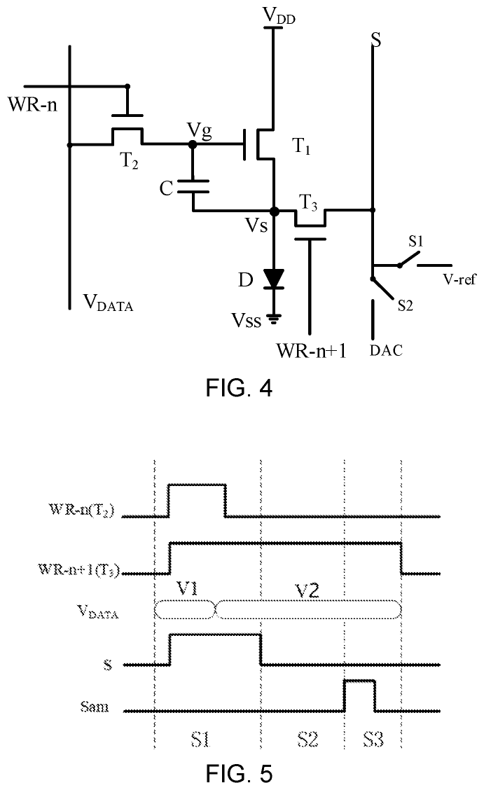

In an embodiment of the present invention, referring to FIG. 4, the pixel circuit further comprises a reference voltage line and a data acquisition chip. The reference voltage line is connected to a detection signal line S through a reference voltage switch S1, and the data acquisition chip is connected to the detection signal line S through a data acquisition switch S2.

In an embodiment of the present invention, referring to FIG. 4, the pixel circuit further comprises an external control unit connected to the scan line and the scan line in the last row of the pixel unit circuit to control a pulse of the scan line of the pixel circuit. This makes at least half of pulses of the scan lines of adjacent rows in the pixel circuit the same. The scan lines of the pixel unit circuits of adjacent rows have at least half of pulses being the same, and may be: in this pixel circuit, at least half of pulse signals of the scan lines (including the scan line in the last row) in previous and next rows are at high-level signal at the same time. This allows the second transistor T2 and the third transistor T3 controlled by the scan line signals of the previous row and the next row respectively to be turned on simultaneously. As an implementable manner, the pulse signal diagram of the scan lines can be referred to FIG. 3 and FIG. 5, and FIG. 4 is combined with the pixel unit circuit 10 structure diagram. The detection process of the pixel circuit can be divided into an initial stage, a detection stage, and a data reading stage.

In an initial stage S1, the scan line WR-n of the pixel unit circuit 10 in the nth row is in a high-level state, the second transistor T2 of the pixel unit circuit 10 in the row is turned on. The scan line WR-n+1 of the pixel unit circuit 11 in the n+1th row is in a high-level state to turn on the third transistor T3. At this time, the reference voltage switch S1 is turned on, and a reference voltage is provided to the pixel unit circuit 10 through the detection signal line S. The data line VDATA is in a low-level state. The light emitting device D does not emit light and is in a black insertion stage V1. After that, the data line V_{DATA} is raised to a high-level state to turn on the first transistor T1, and starts to charge the storage capacitor C, and the light emitting device D starts to emit light, which is a light emitting stage V2. After the scan line WR-n+1 of the pixel unit circuit 11 in the n+1th row is raised to the high-level state for 1H time, the scan line WR-n+1 of the pixel unit circuit 10 in the nth row is reduced to low-level state. The second transistor T2 is turned off, and the first transistor T1 remains turned on because the storage capacitor C starts to discharge to the outside. The voltage at the source point Vs of the first transistor T1 is raised, and the voltage at the gate point Vg of the first transistor T1 is coupled to the storage capacitor C due to the voltage drift.

In a detection phase S2, the reference voltage switch S1 is turned off, and the reference voltage is not provided through the detection signal line S. The scan line WR-n of the pixel unit circuit 10 in the nth row is maintained in a low-level state. The second transistor T2 remains off. The scan line WR-n+1 of the pixel unit circuit 11 in the n+1th row is maintained in a high-level state. The third transistor T3 is kept on, and the storage capacitor C is kept in a discharged state. The voltage at the source point Vs of the first transistor T1 and the voltage at the gate point Vg of the first transistor T1 remain unchanged.

In a data reading phase S3, the reference voltage switch S1 remains closed and still stops supplying the reference voltage. The scan line WR-n of the pixel unit circuit 10 in the nth row is maintained in a low-level state. The second transistor T2 remains off. The scan line WR-n+1 of the pixel unit circuit 11 in the n+1th row is maintained in a high-level state. The third transistor T3 of the pixel unit circuit 10 in the nth row remains on. At this time, a data read switch Sam is turned on. The data reading chip reads the gate-source voltage Vgs of the first transistor T1T1 through the detection signal line S. The gate-source voltage Vgs is equal to the difference between the gate voltage Vg and the source voltage Vs of the first transistor T1.

After the data reading chip detects the more accurate gate-source voltage of the first transistor T1 through the detection signal line S, the data is processed and the compensation voltage is calculated. The voltage of the data line V_{DATA} in the next frame is adjusted according to the compensation voltage to achieve voltage compensation for the pixel circuit.

In an embodiment of the present invention, in the pixel circuit, the control electrode of the third transistor T3 of the pixel unit circuit 10 in the nth row is connected to the scan line WR-n+1 of the pixel unit circuit 11 in the n+1th row, and at least half of pulses of the scan lines of the pixel unit circuits in the adjacent rows are controlled to be the same. Structures such as the scan line in the last row, reference voltage line, and data read chip are added. This can make the gate-source voltage of the first transistor T1 read by the detection data of the detection signal line S more accurate, thereby improving the detection accuracy of the pixel circuit and the compensation accuracy of the pixel circuit. In addition, since the pixel circuit architecture of a single scanning line is still used, only adding the scan line in the last row can still ensure a high aperture ratio of the pixel structure and achieve better display performance.

An embodiment of the present invention also provides a display device. The display device includes a pixel circuit. The pixel circuit has the same or similar structure or function as the pixel circuit in the above embodiments, so that the display device has a better display performance.

Although the present invention has been shown and described with respect to one or more implementations, those skilled in the art will recognize equivalent variations and modifications upon reading and understanding the present specification and drawings. The present invention includes all such modifications and alterations and is limited only by the scope of the following claims. In particular with regard to the various functions performed by the aforementioned components, the terminology used to describe such components is intended to correspond to any component (unless otherwise indicated) that performs the specified function of the component (e.g., it is functionally equivalent), even if it is not structurally equivalent to the disclosed structure that performs the functions in the exemplary implementation of the present specification shown herein. Moreover, although certain features of this description have been disclosed with respect to only one of several implementations, such a feature may be combined with one or more other features, such as other implementations that may be desirable and advantageous for a given or specific application. Moreover, to the extent that the terms “including,” “having,” “containing,” or variations thereof are used in the detailed description or claims, such terms are intended to be included in a manner similar to the term “comprising.” Further, it should be understood that the “plurality” mentioned herein refers to two or more. For the steps mentioned in this article, the suffixes of numbers are only used to clearly describe the embodiments and are easy to understand. They do not completely represent the order in which the steps are performed, and the order of logical relationships should be used for thinking.

The above description is only an embodiment of the present invention, and thus does not limit the patent scope of the present invention. All equivalent structure or equivalent process transformations made by using the description and drawings of the present invention, such as the mutual combination of technical features between the embodiments, or directly or indirectly used in other related technical fields, are all included in the patent protection scope of the present invention.

What is claimed is:

1. A pixel circuit, comprising:
pixel unit circuits arranged in a row, wherein each of the pixel unit circuits comprises a first transistor, a second transistor, a third transistor, a storage capacitor, a light emitting device, a data line, a scan line, and a detection signal line;
wherein a drain of the first transistor of the pixel unit circuit in a nth row is connected to a first power line to receive a first voltage; a control electrode of the second transistor is connected to the scan line, a first electrode of the second transistor is connected to the data line, and a second electrode of the second transistor is connected to a control electrode of the first transistor and an electrode of the storage capacitor; a control electrode of the third transistor is connected to the scan line of the pixel unit circuit in a n+1th row, a first electrode of the third transistor is connected to the detection signal line, and a second electrode of the third transistor is connected to a source of the first transistor, another electrode of the storage capacitor, and an end of the light emitting device; another end of the light emitting device is connected to a second power line to receive a second voltage; the scan lines of the pixel unit circuits in adjacent rows have at least half of pulses being the same, the control electrode of the third transistor of the pixel unit circuit in a last row is connected to the scan line in a last row, and the detection signal line is configured to provide a reference voltage for the pixel unit circuit.

2. The pixel circuit according to claim 1, further comprising an external control unit connected to the scan line and the scan line in the last row of the pixel unit circuit to control a pulse of the scan line of the pixel circuit.

3. The pixel circuit according to claim 2, wherein the scan lines of adjacent rows of the pixel circuit have at least half of pulses being the same.

4. The pixel circuit according to claim 3, further comprising a reference voltage line and a data acquisition chip, wherein the reference voltage line is connected to a detection signal line through a reference voltage switch, and the data acquisition chip is connected to the detection signal line through a data acquisition switch.

5. A pixel circuit, comprising:
pixel unit circuits arranged in a row, wherein each of the pixel unit circuits comprises a first transistor, a second transistor, a third transistor, a storage capacitor, a light emitting device, a data line, a scan line, and a detection signal line;
wherein a drain of the first transistor of the pixel unit circuit in a nth row is connected to a first power line to receive a first voltage; a control electrode of the second transistor is connected to the scan line, a first electrode of the second transistor is connected to the data line, and a second electrode of the second transistor is connected to a control electrode of the first transistor and an electrode of the storage capacitor; a control electrode of the third transistor is connected to the scan line of the pixel unit circuit in a n+1 th row, a first electrode of the third transistor is connected to the detection signal line, and a second electrode of the third transistor is connected to a source of the first transistor, another electrode of the storage capacitor, and an end of the light emitting device; another end of the light emitting device is connected to a second power line to receive a second voltage; the scan lines of the pixel unit circuits in adjacent rows have at least half of pulses being the same.

6. The pixel circuit according to claim 5, further comprising the scan line in a last row connected to the control electrode of the third transistor of the pixel unit circuit in a last row.

7. The pixel circuit according to claim 6, further comprising an external control unit connected to the scan line and the scan line in the last row of the pixel unit circuit to control a pulse of the scan line of the pixel circuit.

8. The pixel circuit according to claim 7, wherein the scan lines of adjacent rows of the pixel circuit have at least half of pulses being the same.

9. The pixel circuit according to claim 8, further comprising a reference voltage line and a data acquisition chip, wherein the reference voltage line is connected to a detection signal line through a reference voltage switch, and the data acquisition chip is connected to the detection signal line through a data acquisition switch.

10. The pixel circuit according to claim 9, wherein the second power line is grounded, and the second voltage is 0 V.

11. The pixel circuit according to claim 10, wherein the light emitting device is an active matrix organic light emitting diode (AMOLED).

12. The pixel circuit according to claim 11, wherein the first transistor, the second transistor, and the third transistor are all thin film transistors.

13. A display device, comprising:
a pixel circuit comprising pixel unit circuits arranged in a row, wherein each of the pixel unit circuits comprises a first transistor, a second transistor, a third transistor, a storage capacitor, a light emitting device, a data line, a scan line, and a detection signal line;
wherein a drain of the first transistor of the pixel unit circuit in a nth row is connected to a first power line to receive a first voltage; a control electrode of the second transistor is connected to the scan line, a first electrode of the second transistor is connected to the data line, and a second electrode of the second transistor is connected to a control electrode of the first transistor and an electrode of the storage capacitor; a control electrode of the third transistor is connected to the scan line of the pixel unit circuit in a n+1th row, a first electrode of the third transistor is connected to the detection signal line, and a second electrode of the third transistor is connected to a source of the first transistor, another electrode of the storage capacitor, and an end of the light emitting device; another end of the light emitting device is connected to a second power line to receive a second voltage; the scan lines of the pixel unit circuits in adjacent rows have at least half of pulses being the same.

14. The display device according to claim 13, wherein the pixel comprises the scan line in a last row connected to the control electrode of the third transistor of the pixel unit circuit in a last row.

15. The display device according to claim 14, wherein the pixel circuit further comprises an external control unit connected to the scan line and the scan line in the last row of the pixel unit circuit to control a pulse of the scan line of the pixel circuit.

16. The display device according to claim 15, wherein the scan lines of adjacent rows of the pixel circuit have at least half of pulses being the same.

17. The display device according to claim 16, wherein the pixel circuit further comprises a reference voltage line and a data acquisition chip, wherein the reference voltage line is connected to a detection signal line through a reference voltage switch, and the data acquisition chip is connected to the detection signal line through a data acquisition switch.

18. The display device according to claim 17, wherein the second power line is grounded, and the second voltage is 0 V.

19. The display device according to claim 18, wherein the light emitting device is an active matrix organic light emitting diode (AMOLED).

20. The display device according to claim 19, wherein the first transistor, the second transistor, and the third transistor are all thin film transistors.
